(19) United States
(12) Patent Application Publication
(10) Pub. No.: US 2011/0001326 A1
(43) Pub. Date: Jan. 6, 2011

(54) Plow shovel

(76) Inventor: Howard E. Towles, Crete, IL (US)

Correspondence Address: Howard E. Towles, 23754 Kurt Lane, Crete, IL, 60417, US

(21) Appl. No.: 12/459,607

(22) Filed: Jul. 6, 2009

(51) Int. Cl. E01H 5/02; A01B 1/02; A01B 1/22

(52) U.S. Cl. 294/53.5

(57) ABSTRACT

A manually operable shovel for efficiently moving material, including a shovel blade, a shovel handle, a threaded joint for attaching the shovel blade to a pivotal collar which attaches the shovel handle shaft to a shovel blade joint, by means of a pressure fit socket interconnected to a support articulation device permanently affixed to the shovel blade, cooperating with the support member for positioning the blade to a pre-determined fixed angle relative to the direction of the blade movement, attaching the shovel handle shaft to the respective fixed angle settings by pressure fit sockets oriented generally at the respective handle/blade junction.

The pivotal collar cooperates with the shovel handle shaft to allow the shovel handle to angularly swivel as required to lock the pre-determined pressure fit sockets located at the lower span of the sides and center of the shovel blade relative to the axis of the upper support articulation device securing the handle.

The pressure fit connectors retain the handle in the pre-determined angles as engaged until overcome by rearward force against the shovel blade applied by the operator, disengaging at pressure fit sockets oriented at the respective handle/blade junctions, partially disengaging the shovel blade from handle shaft. The pivotal collar cooperates with the shovel handle shaft to allow the shovel handle to extend and distend as required to reengage at the pre-determined pressure fit sockets located at the lower span of the sides and center of the shovel blade relative to the axis of the upper support articulation device securing the handle.

### FIELD OF THE INVENTION

This invention relates to a shovel particularly adapted for being manually used to shovel snow and other material, for example, mud, leaves, other yard debris and sawdust. The term “shovel” as used herein refers interchangeably to an implement which can be used to shovel i.e., lift, push and displace, the materials.

Manually shoveling snow and other heavy material is physically demanding. Users generally alternate between a true “shoveling” motion where a quantity of the material is displaced from a surface onto the blade, the blade is lifted and the materials thrown off of the blade, and a “plowing” motion, where the shovel is pushed along the ground, pushing the material in advance of the blade. The “plowing” motion as referenced is potentially more efficient, since more material can be moved, without the need of lifting both the shovel and the material off of the ground. This motion can be much less demanding on the shoulders, back and arms. However, a conventional shovel handle does not provide sufficient stability to easily and efficiently guide the shovel, particularly when the blade is pushing a large quantity of material.

Moreover, the fixed position of the blade with reference to the handle does not permit the user to shovel straight along, for example, a walk or driveway, while diverting the material off to the side in a plowing motion. The invention disclosed and claimed in this application presents a solution to these and other problems.

### CROSS REFERENCE TO RELATED APPLICATIONS

U.S. Pat. No. 4,264,096
U.S. Pat. No. 3,473,838
U.S. Pat. No. 2,46,150
U.S. Pat. No. 3,222,699
U.S. Pat. No. 1,074,889
U.S. Pat. No. 1,896,568
U.S. Pat. No. 2,919,153
U.S. Pat. No. 4,538,847
U.S. Pat. No. 3,078,604
U.S. Pat. No. D187,874
U.S. Pat. No. 2,266,542
U.S. Pat. No. 6,053,548
U.S. Pat. No. 5,829,808
U.S. Pat. No. 1,667,591
U.S. Pat. No. 813,983
U.S. Pat. No. 2,967,363
U.S. Pat. No. 4,597,204
U.S. Pat. No. 6,315,341
U.S. Pat. No. 7,156,435
U.S. Pat. No. 4,264,095

### BACKGROUND OF THE INVENTION

I am aware that the prior art discloses various forms of so-called combination snow shovel and plow devices wherein means are provided to adjust the handle member of the tool relative to the blade portion thereof in an attempt to render the tool operable either as a shovel or as a plow. However, to my knowledge, prior combination tools of this character have never made provision for relative adjustment of the handle and blade members in a manner by which the tool may be efficiently and comfortably operated in its respective capacities. In prior art devices of which I am aware, the inner end of the handle member is usually secured to the rear side of the blade member so as to permit lateral pivotal or swinging movement of the handle relative to the blade or vice versa, in only one plane, thus failing to make any provision for relative adjustment in the line of draft of the handle such as is ordinarily required between snow shovels on the one hand and snow plows on the other.

Some examples which are illustrative of the prior art include U.S. Pat. No. 4,264,096 which discloses a shovel having two handles, one in a fixed position and the other fixed in any angular position, but connected by an eye bolt to the blade or scoop for free swinging relationship therewith.

U.S. Pat. No. 3,473,838 discloses a shovel having a handle which can be positioned as different angles to the blade in the vertical direction only.

U.S. Pat. No. 2,46,150 discloses a snow shovel in which the handle can be rigidly held in a vertical plane relative to a horizontally extending blade, which includes a swing bar or clamping lever 27 that allows the handle to become free swinging relative to the blade when the clamping lever 27 is swung outwardly as shown in FIG. 4 of that patent.

U.S. Pat. No. 3,222,699 discloses a shovel having a handle with a bend at an intermediate point thereon. It is connected to the blade at a permanently fixed angle.

U.S. Pat. No. 1,074,889 discloses a shovel having an auxiliary handle extending forwardly of the shovel blade.

U.S. Pat. No. 1,896,568 discloses a digging instrument, comprising a shovel on one end and a fork or rake type tool on the other end, connected to the handle by a pivotable member which enables rotating the digging instrument so the shovel end is in the working position axially aligned with the handle and when rotated one hundred eighty degrees the fork or rake end is in the working position axially aligned with the handle.

U.S. Pat. No. 2,919,153 discloses a snow shovel in which the handle can be rigidly held in a vertical plane relative to a horizontally extending blade, which includes a shank collar that allow the handle to shift in position on an upper bracket.

U.S. Pat. No. 4,538,847 discloses a snow shovel in which the shovel handle is rotatable within a centrally mounted tubular insert offering a center angular intermediate insert for the handle.

U.S. Pat. No. 3,078,604 discloses a shovel having a handle with a bend at an intermediate point thereon; it is connected to a blade at a permanently fixed angle.

U.S. Pat. No. D187,874 discloses a shovel having a handle permanently angularly attached to a blade support on by skids.

U.S. Pat. No. 2,266,542 discloses a snow shovel with a handle attached to the blade held by a pin allowing the handle to turn in radius held by a lower guide slot.

U.S. Pat. No. 6,053,548 discloses a snow shovel with a handle attached to the blade held by pins mounted to a plate inserted in the handle to allow the handle to swivel the handle on radius relative to angle of the blade.

U.S. Pat. No. 5,829,808 discloses a snow shovel with a handle attached to a fastener on the handle to allow the handle to be adjusted from side to side.

U.S. Pat. No. 1,667,591 discloses a snow shovel with a handle mounted by screws in pre-drilled holes allowing the handle to turn against a center mount axle.

U.S. Pat. No. 813,983 discloses a snow shovel comprising a curved blade, pivotable connected to a handle and with a curved slot held by a bolt passing through the slot, connected to the handle permitting the blade lateral movement on its pivot.

U.S. Pat. No. 2,967,363 discloses a snow shovel with a handle attached to a two-tired plate by two-in-line screws to allow the handle to turn right or left by removing manually the forward screws to turn the handle to fit pre-drilled holes in the mounting plate.

U.S. Pat. No. 4,597,204 discloses a snow pushed with a handle pivotally attached to a large plate at the back of the snow device member, allowing the angle of the handle relative to the length of the blade to be adjusted.

U.S. Pat. No. 6,315,341 discloses a shovel having an adjustable blade angle for changing the angle of the blade with respect to the handle.

U.S. Pat. No. 7,156,435 discloses a snow shovel with a blade attached enabling the operator to displace the snow to one side.

U.S. Pat. No. 4,264,095 discloses a snow shovel with a blade assembly incurring a pair of generally right angular first and second section joined together with a mount supported from the second blade assemble with the handle supported thereon, pivotably secured for angular adjustment on axis traverse to the handle.

In all such prior art of which I am aware, a resulting increase in the center of gravity of the fulcrum of various shovel blade settings causes inefficient performance due to unavoidable weight distribution and unavoidable stress during use.

These problems, including reducing the center of gravity of the angular settings, are solved by the duplex locking handle of this invention, by and including, but not limited to, reducing the progressive resistance of the material moved to the amount of inertial force necessary.

While the above devices each may be useful for its intended purpose, it would be beneficial to the field to have a radiused, pivotably pitched blade, plow shovel as described in this invention which overcomes these limitations.

### SUMMARY OF THE INVENTION

Accordingly, it is the object of the present invention to improve generally on prior art combination snow shovel and plow tools through the provisions of a shovel and efficient means for connecting and selectively locking the handle element of the tool to the blade member thereof, in a manner whereby the single tool may be quickly and easily converted to either a snow shovel or snow plow.

It is another object of the invention to provide a manually-operable shovel which is simple to use and maintain.

It is another object of the invention to provide a manually-operable shovel which can be used interchangeably with a shoveling and plowing motion.

It is another object of the invention to provide a manually-operable shovel having a blade which can be articulated with reference to the direction of movement of the shovel to divert material to the side.

It is yet another object of the invention to provide a manually-operable shovel which efficiently overcomes inertial resistance of the material moved.

It is another object of the invention to provide a manually operable shovel which efficiently overcomes weight and load resistance of the material moved.

It is yet another object of the invention to provide a manually-operable shovel which is easy to store and maintain, whereas: the handle can be quickly removed after use; the two moving parts of this invention require virtually no maintenance.

It is another object of the invention to provide a manually-operable shovel which is less labor-intensive.

It is yet another object of the invention to provide a manually-operable shovel which is less likely to cause over-exertion of the user.

### LEGEND OF A PREFERRED EMBODIMENT

### Item Number:

1. SHOVEL BLADE
2. SLIDING PIVOTAL COLLAR
3. SHOVEL HANDLE SHAFT
4. BLADE ANGLE CONNECTOR MEANS-MALE SOCKET MEMBER
5. SHOVEL HANDLE SHAFT-FEMALE SOCKET MEMBER
6. HITCH PIN
7. ARTICULATION MEANS-MALE SOCKET MEMBER
8. ARTICULATION MEANS-FEMALE SOCKET MEMBER
9. ARTICULATION MEANS
10. FOOT SUPPORT
11. BLADE ANGLE CONNECTOR MEANS
12. STABILIZER SUPPORT
13. SLIDING PIVOTAL COLLAR-THREADED GUIDE
14. ARTICULATION MEANS-MALE SOCKET MEMBER CONNECTOR NUT
15. BOLT-HITCH PIN ALTERNATE
16. NUT-HITCH PIN ALTERNATE
17. SHOVEL HANDLE SHAFT-RETAINING RING
18. PRE-DRILLED OPENING

### IN THE DRAWINGS

FIG. 1 is a three-dimensional rear view of the device showing the shovel blade, articulation means-male socket member, articulation means-female socket member, stabilizer support, articulation means, hitch pin, shovel handle shaft, blade angle connector means, sliding pivotal collar, shovel handle shaft retaining ring, shovel handle shaft-female socket member, blade angle connector means-male socket member and foot support.

FIG. 2 is a three dimensional front view of the device showing the shovel blade, articulation means and stabilizer support.

FIG. 3 is a three dimensional rear view of the underside of the device showing the shovel blade, blade angle connector means-male socket member, foot support, blade angle connector means, stabilizer support, and articulation means.

FIG. 4 is a side view of FIG. 3 showing the structural dimensions of shovel blade radius, shovel blade height, articulation means, stabilizer support, blade angle connector means and foot support.

FIG. 5 is a rear view of FIG. 3 showing the structural dimensions of shovel blade width, foot support, blade angle connector means, blade angle connector means-male socket member, articulation means, and stabilizer support.

FIG. 6 is a three dimensional close-up view of the articulation means-female socket member and articulation means-male socket member showing the opposite end of male socket member embedded with connector nut, and pre-drilled openings.

FIG. 7

a. is a three dimensional close-up group view showing the shovel handle shaft, sliding pivotal collar, articulation means-male socket member and articulation means-female socket member connected, said socket member(s) secured by hitch pin or by bolt and nut alternative, articulation means, and showing the articulation-means male socket member connector nut corresponding to the sliding pivotal collar-threaded guide.
b. is a three dimensional close-up view showing the articulation means-male socket member connector nut positioned to connect to the sliding pivotal collar-threaded guide of the shovel handle shaft, and showing the pre-drilled opening of the articulation means-male socket member.

FIG. 8

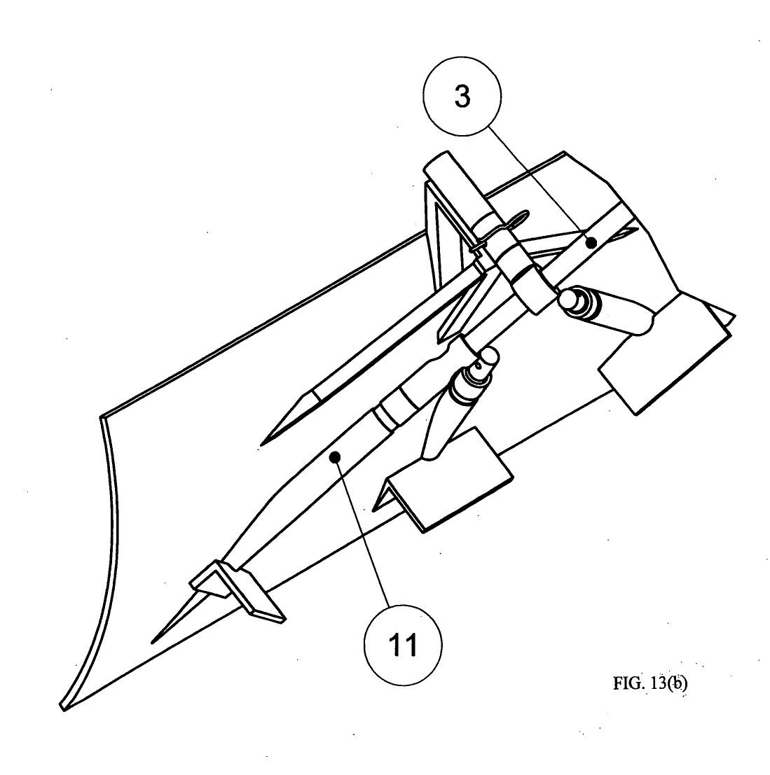

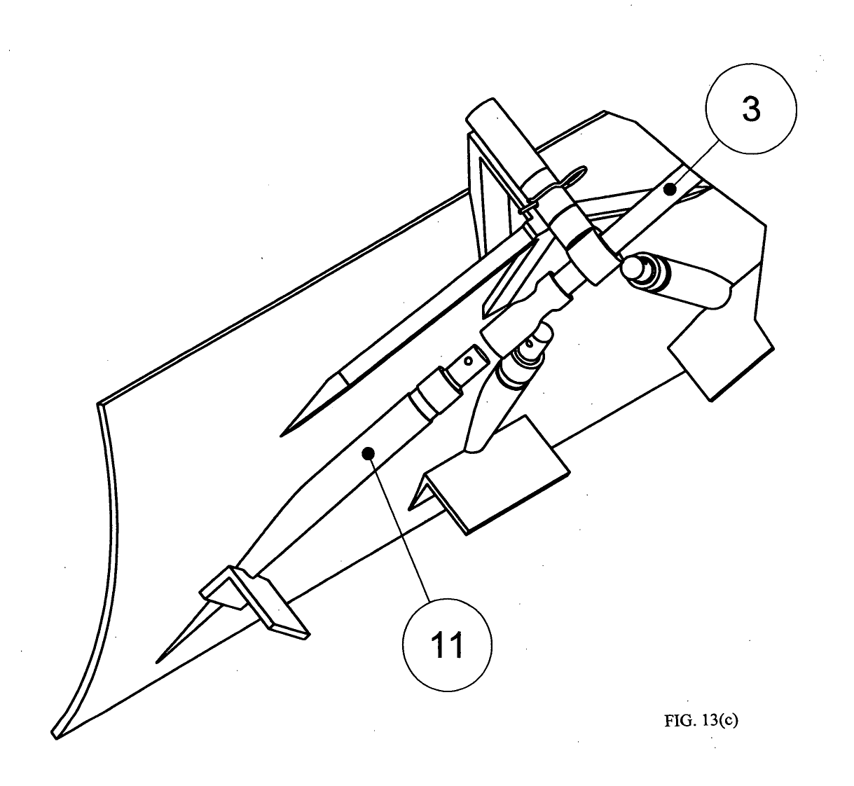

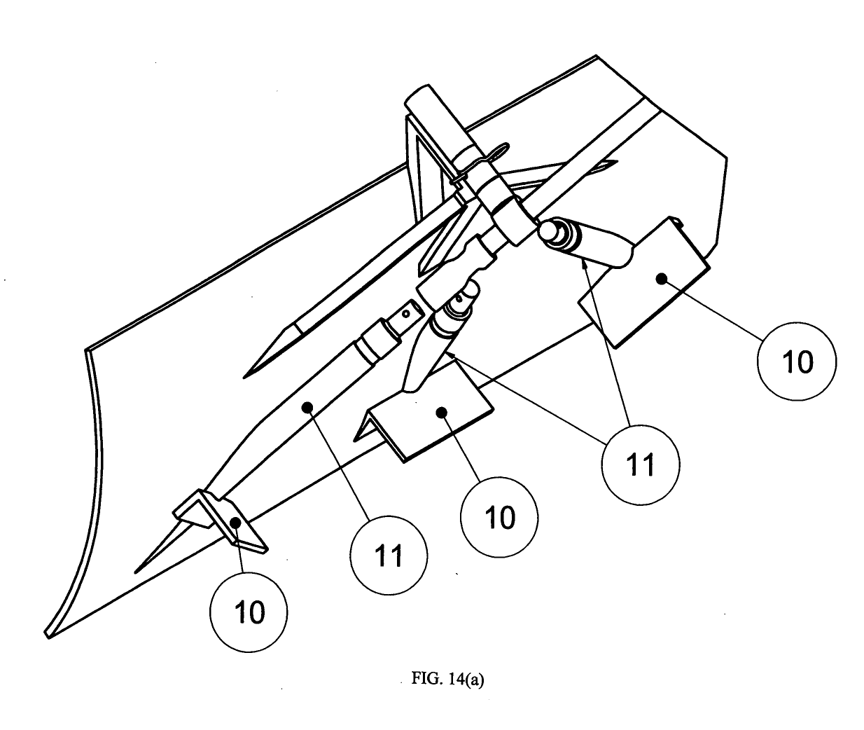

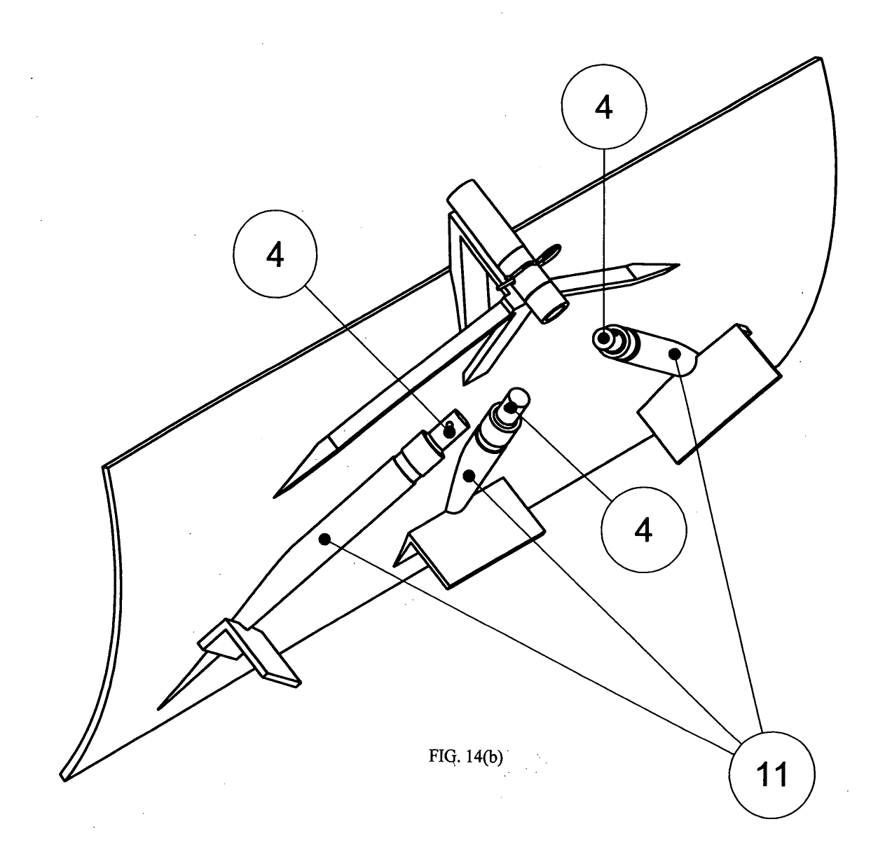

a. is a three dimensional assembly sequence diagram of FIG. 7b showing the shovel handle shaft positioned to connect to the articulation means-male socket member by means of clockwise rotating method of said socket member on the sliding pivotal collar-threaded guide.
b. is a three dimensional assembly sequence diagram of FIG. 7b showing the shovel handle shaft connecting to the articulation means-male socket member by means of clockwise rotating method of said socket member on the sliding pivotal collar-threaded guide.
c. is a three dimensional assembly sequence diagram of FIG. 8b showing the shovel handle shaft connected to said socket member.
d. is a three dimensional disassembly sequence diagram of the shovel handle shaft disconnected from said socket member by counter-clockwise rotating method of said socket member off the sliding pivotal collar-threaded guide.

FIG. 9

a. is a three dimensional assembly close-up sequence diagram showing the shovel handle shaft, sliding pivotal collar, and articulation means-male socket member as shown in FIG. 8c positioned to engage the articulation means-female socket member at the articulation means by forward sliding method.
b. is a three dimensional assembly close-up sequence diagram of FIG. 9a showing the articulation means-male socket member engaged to the articulation means-female socket member.
c. is a three dimensional disassembly close-up sequence diagram of FIG. 9a showing the articulation means-male socket member disengaged from the articulation means-female socket member by reverse sliding method.

FIG. 10

a. is a three dimensional assembly close-up diagram of the shovel handle shaft as shown in FIG. 9b ready to secure to the articulation means by forward sliding of hitch pin or by inserting bolt hitch-pin alternate in pre-drilled opening, nut-hitch pin alternate securing to said bolt by clockwise method.
b. is a three dimensional assembly close-up diagram of FIG. 10a showing the shovel handle shaft secured to articulation means by hitch-pin.
c. is a three dimensional disassembly close-up diagram of the shovel handle shaft unsecured from engagement to articulation member by reverse sliding method after removing hitch pin or after removing bolt-hitch pin alternate, nut-hitch pin alternate disconnected from said bolt by counter-clockwise method.

FIG. 11

a. is a three dimensional close up view of the shovel handle shaft-retaining ring attached to the shovel handle shaft at the shovel handle shaft-female socket member.
b. Is a three dimensional close up view of FIG. 11a further showing the sliding pivotal collar retained by the shovel handle shaft-retaining ring on the shovel handle shaft.

FIG. 12

a. is a three dimensional assembly close-up view of the shovel handle shaft-female socket member positioned to engage a blade angle connector means by forward sliding method into the blade angle connector means-male socket member.
b. is a three dimensional assembly close-up sequence diagram of FIG. 12a showing the shovel handle shaft engaged to a blade angle connector means.
c. is a three dimensional disassembly close-up sequence diagram of FIG. 12a showing the shovel handle shaft disengaged from a blade angle connector means by reverse sliding method from the blade angle connector means-male socket member.

FIG. 13

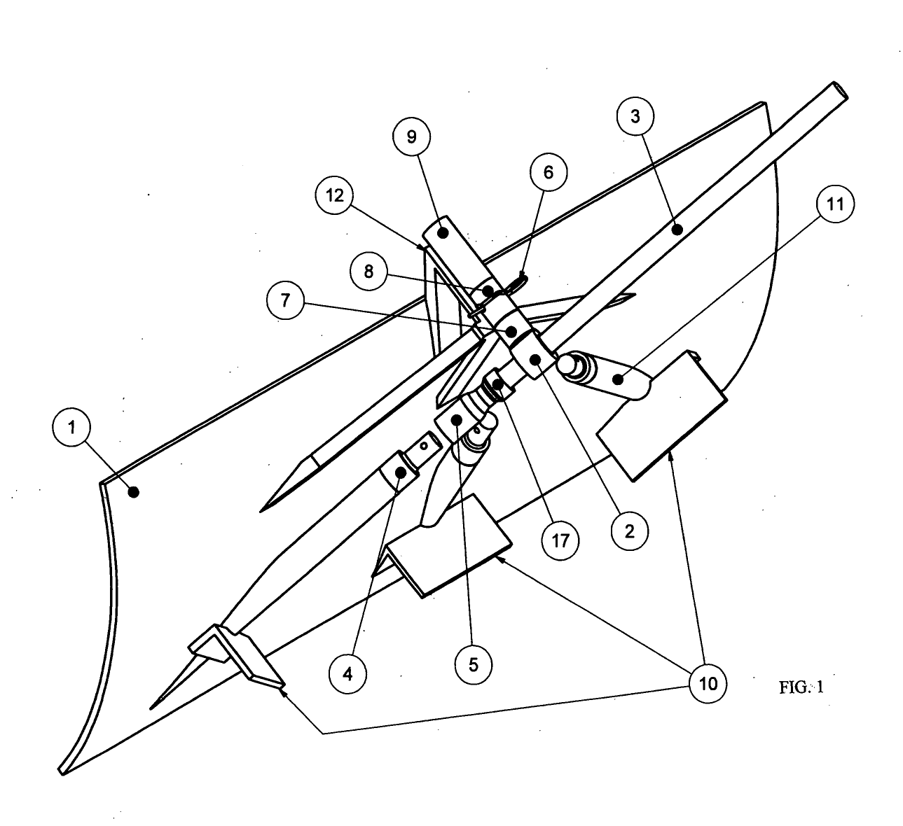

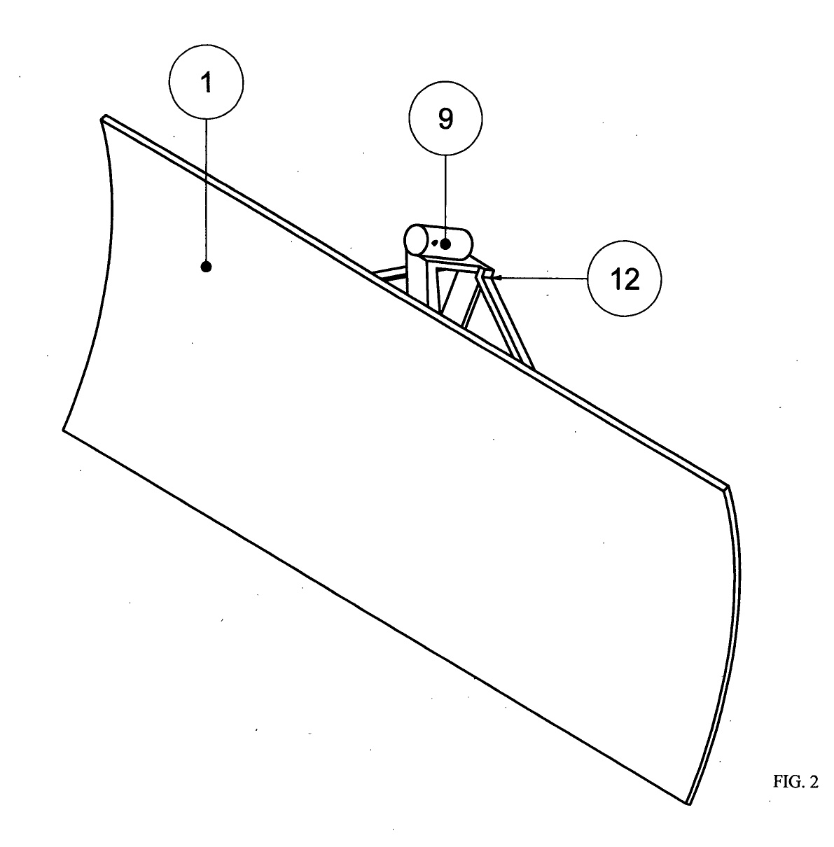

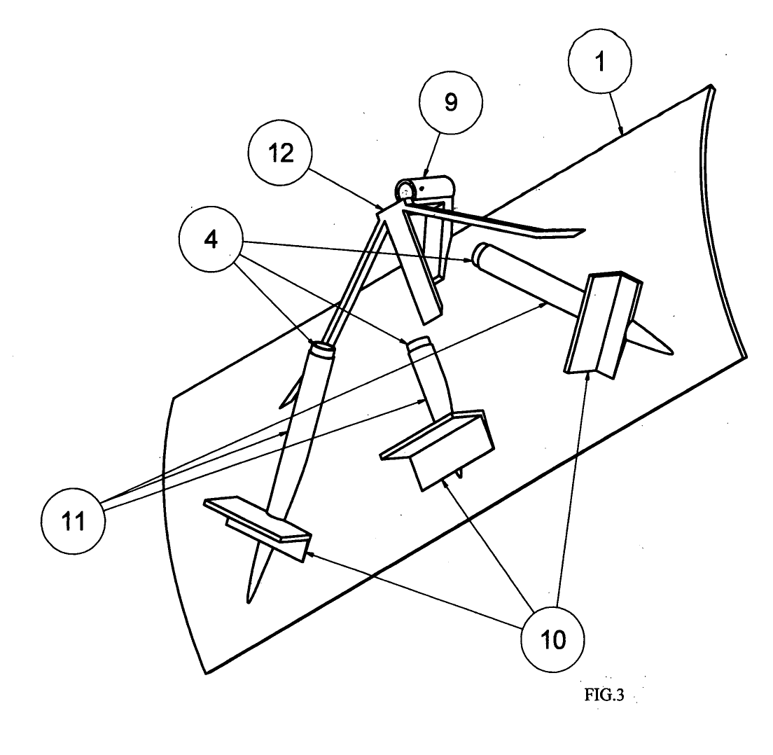

a. is a three dimensional rear view assembly sequence partial diagram of FIG. 1 showing the shovel handle shaft positioned to engage a blade angle connector means by forward sliding method.
b. is a three dimensional rear view assembly sequence partial diagram of FIG. 1 showing the shovel handle shaft engaged to a blade angle connector means.
c. is a three dimensional rear view disassembly partial diagram of FIG. 1 showing the shovel handle shaft disengaged from a blade angle connector means by reverse sliding method.

FIG. 14

a. is a three dimensional rear view partial diagram of FIG. 1 showing the foot support below each blade angle connector means.
b. is a three dimensional rear view diagram of FIG. 1, shovel handle shaft detached, showing each blade angle connector means-male socket member and the blade angle connector means.

### LEGEND OF A PREFERRED EMBODIMENT

### Item Number:

1. SHOVEL BLADE
2. SLIDING PIVOTAL COLLAR
3. SHOVEL HANDLE SHAFT
4. BLADE ANGLE CONNECTOR MEANS-MALE SOCKET MEMBER
5. SHOVEL HANDLE SHAFT-FEMALE SOCKET MEMBER
6. HITCH PIN
7. ARTICULATION MEANS-MALE SOCKET MEMBER
8. ARTICULATION MEANS-FEMALE SOCKET MEMBER
9. ARTICULATION MEANS
10. FOOT SUPPORT
11. BLADE ANGLE CONNECTOR MEANS
12. STABILIZER SUPPORT
13. SLIDING PIVOTAL COLLAR-THREADED GUIDE
14. ARTICULATION MEANS-MALE SOCKET MEMBER CONNECTOR NUT
15. BOLT-HITCH PIN ALTERNATE
16. NUT-HITCH PIN ALTERNATE
17. SHOVEL HANDLE SHAFT-RETAINING RING
18. PRE-DRILLED OPENING

### DESCRIPTION OF A PREFERRED EMBODIMENT

These and other objects of the present invention are achieved in the preferred embodiments disclosed below by providing a manually-operable shovel for efficiently moving material, comprising a shovel blade, a shovel handle shaft, a sliding pivotable collar surrounding the shovel handle shaft, joint means for attaching the shovel blade to the shovel handle shaft and articulation means cooperating with the joint means for permitting the operator to position on axis the blade to a pre-determined fixed angle in relation to the direction of blade movement.

Referring now to the legend of a preferred embodiment, the details of preferred embodiments of the present inventions are disclosed.

The articulation means 9 is mounted upon the stabilizer support 12 from which the angle of shovel blade 1 direction is set.

The articulation means 9 connects the shovel handle shaft 3 to the shovel blade 1 by male socket member 4, secured by threaded guide 13 to the sliding pivotal collar 2.

The threaded guide 13 allows the pivotal collar 2 to swivel in the direction of fixed angle blade settings.

The articulation means 9 allows the shovel handle shaft 3 and collar 2 to position the shovel handle shaft 3 into a locked position in relation to the angle of the blade, wherein the angle of the blade is locked into a fixed angle in relation to the direction of shovel blade 1 movement. The shovel handle shaft 3 swivels on axis at direction of operator to pre-set inter-locking connector means 11 located at the underside edges of shovel blade 1 respective of pre-set positions. This locked position is disengaged by rearward motion to the handle against stationary placement of the operator's foot upon a foot support 10 below the respective underside blade angle connector means 11.

According to one preferred embodiment of the invention, the articulation means comprises a first joint member 8 carried by the shovel blade 1, a second joint member 7 carried by the shovel handle shaft 3, and connector means for connecting the first joint member to the second joint member.

According to another preferred embodiment, the second joint member 7 interlocks by annular pressure fit in the first joint member 8.

According to another preferred embodiment, the articulation means comprises a shovel handle shaft-female socket member 5 opening to intermatingly connect with a blade angle connector means-male socket member 4 attached to a shovel handle shaft 3 sliding pivotable collar 2 whereby the shovel handle shaft 3 pivots on axis to assume a fixed position relative to the blade angle.

According to yet another preferred embodiment of the invention, the sliding pivotable collar 2 comprises a sliding ring surrounding the handle pole anchored by shovel handle shaft-retaining ring 17, cooperating with the shovel handle shaft 3 to permit the operator to extend and distend the shovel handle shaft 3 on axis to blade angle connector means-male socket member 4, located at underside of the shovel blade 1.

According to another preferred embodiment of the invention, the various blade angle connector means-male socket member 4 attached to the lower span of the shovel blade 1 comprise pressure fit sockets spaced for angularly positioning and locking the shovel blade 1 for material engaging movement of the shovel upon forward pressure applied to the shovel handle shaft 3 by the operator when locked into the various blade angle connector means 11.

According to yet another preferred embodiment of the invention, the blade angle connector means 11 are under sided with foot support 10 permitting the operator to stabilize the shovel blade 1 while disconnecting the shovel handle shaft 3 from the respective angular setting.

According to another preferred embodiment of the invention, the articulation means 9 further comprises a stabilizer support 12 correspondingly positioned perpendicular to the sliding pivotable collar 2 to stabilize the shovel during use.

According to yet another preferred embodiment of the invention, the articulation means 9 corresponds to the sliding pivotable collar 2 by sliding pivotable collar-threaded guide 13 accepted by the articulation means-male socket member connector nut 14 housed within the opposite end of the articulation means-male socket member 7 that intermatingly joins to the shovel handle shaft-female socket member 5 affixed to the articulation means 9 upon the stabilizer support 12.

According to another preferred embodiment of the invention, the various blade angle male socket connector means 11 are intermatingly connected by blade angle connector means-male socket member 4 to shovel handle shaft female socket member 5 whereby the shovel handle shaft 3 and shovel blade 1 are locked in a preset angle relative to the direction of shovel blade 1 movement.

According to yet another preferred embodiment of the invention, the articulation means male socket member 7 is secured to the articulation means 9 by hitch-pin 6 or alternatively by bolt 15 and nut 16.

According to yet another preferred embodiment of the invention, the articulation means 9 houses the articulation means-male socket member connector nut 14 corresponding on axis by sliding pivotable collar-threaded guide 13 to blade angle connector means-male socket member 4 whereby the shovel blade 1 is angularly locked in position.

Referring now to the drawings, FIG. 1-14 the details of preferred embodiments of the present invention are graphically, structurally and schematically illustrated.

As shown on FIG. 1, the device comprises a shovel blade 1, articulation means-male socket member 7, articulation means-female socket member 8, stabilizer support 12, articulation means 9, hitch pin 6, shovel handle shaft 3, blade angle connector means 11, sliding pivotal collar 2, shovel handle shaft-retaining ring 17, shovel handle shaft female socket member 5, foot support 10 and blade angle connector means-male socket member 4.

As shown on FIG. 2, is a three dimensional front view of the device showing the blade 1, articulation means 9, and stabilizer support 12.

As shown on FIG. 3, is a three dimensional rear view of the underside of the device where the blade angle connector means 11, blade angle connector means-male socket member 4, stabilizer support 12, articulation means 9, shovel blade 1, and foot support 10 are positioned.

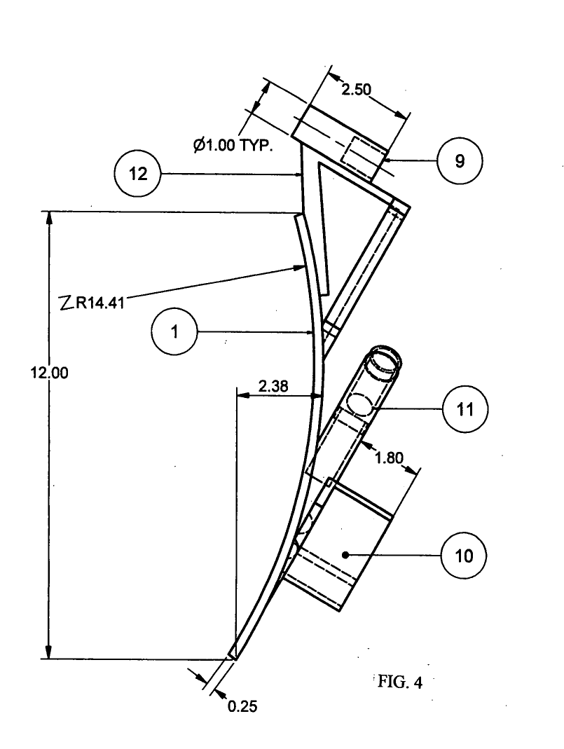

As shown in FIG. 4, is a side view of the device where the shovel blade 1, articulation means 9, stabilizer support 12, blade angle connector means 11, and foot support 10 are positioned.

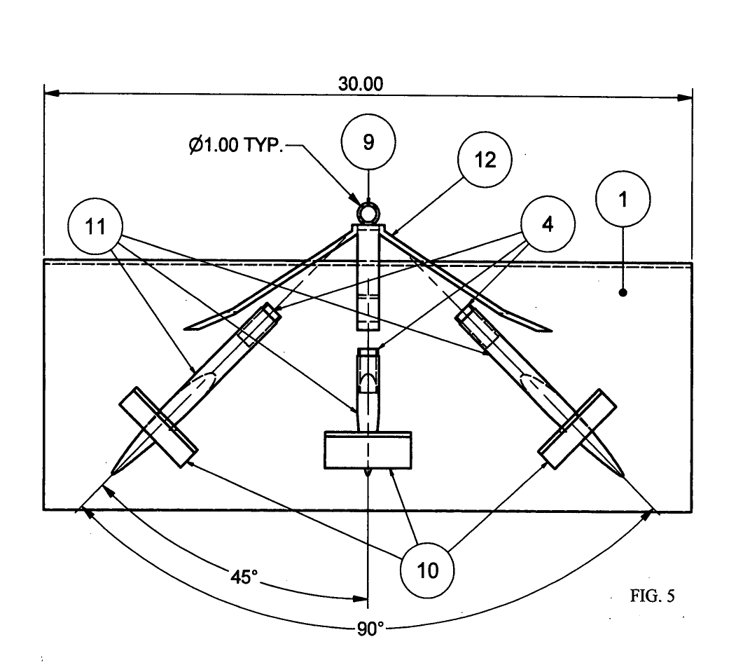

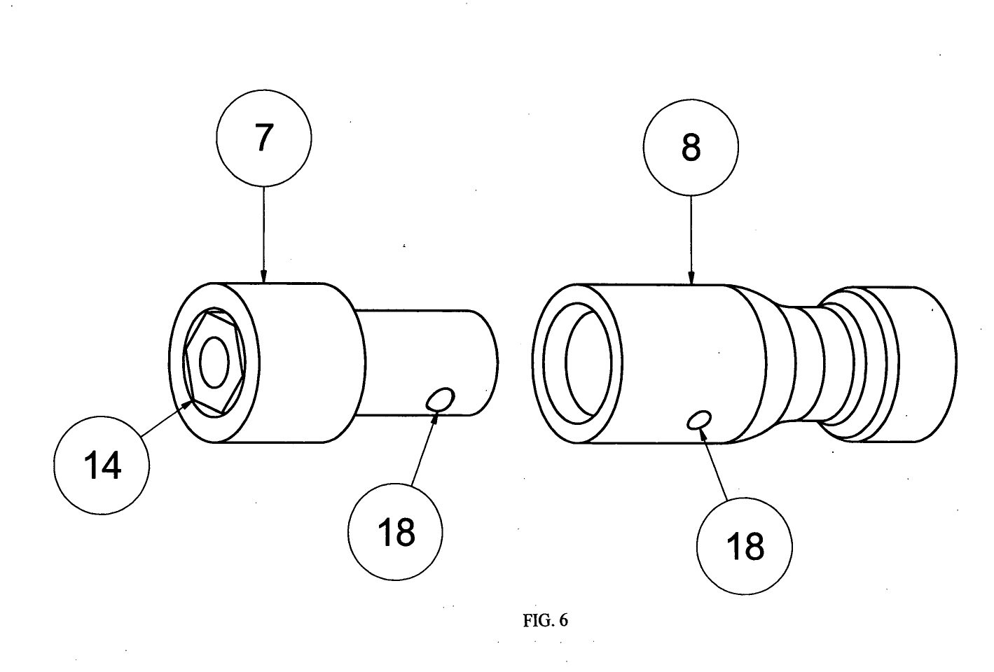

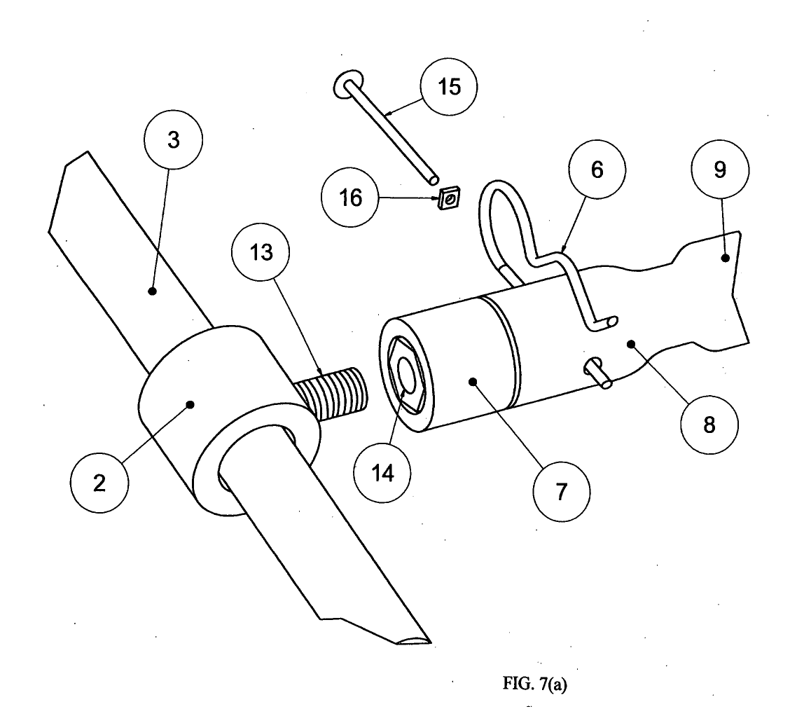

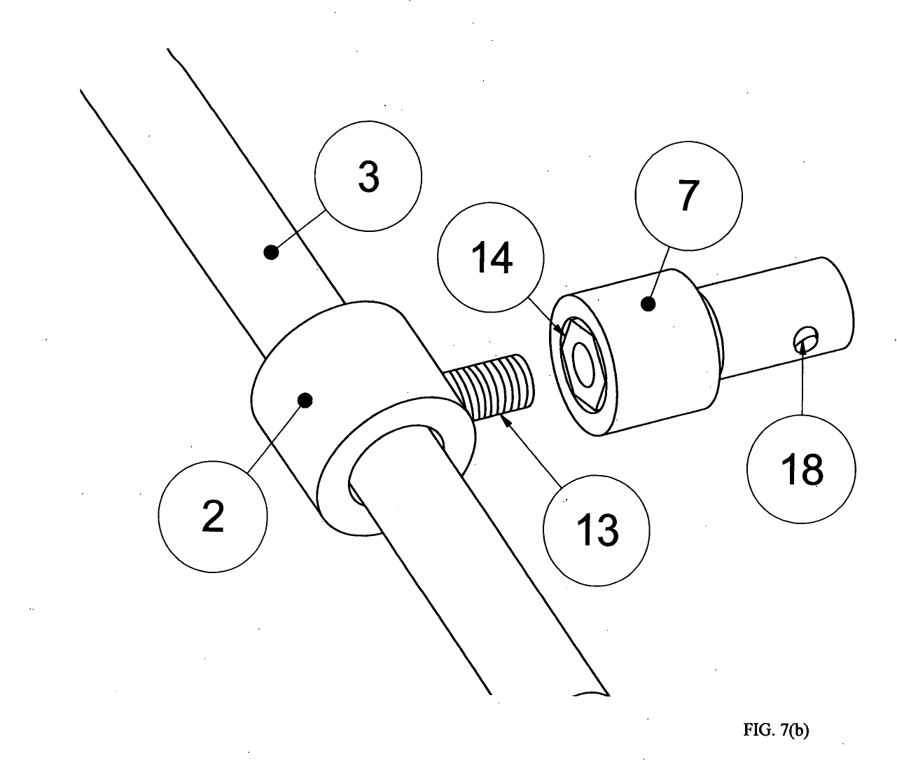

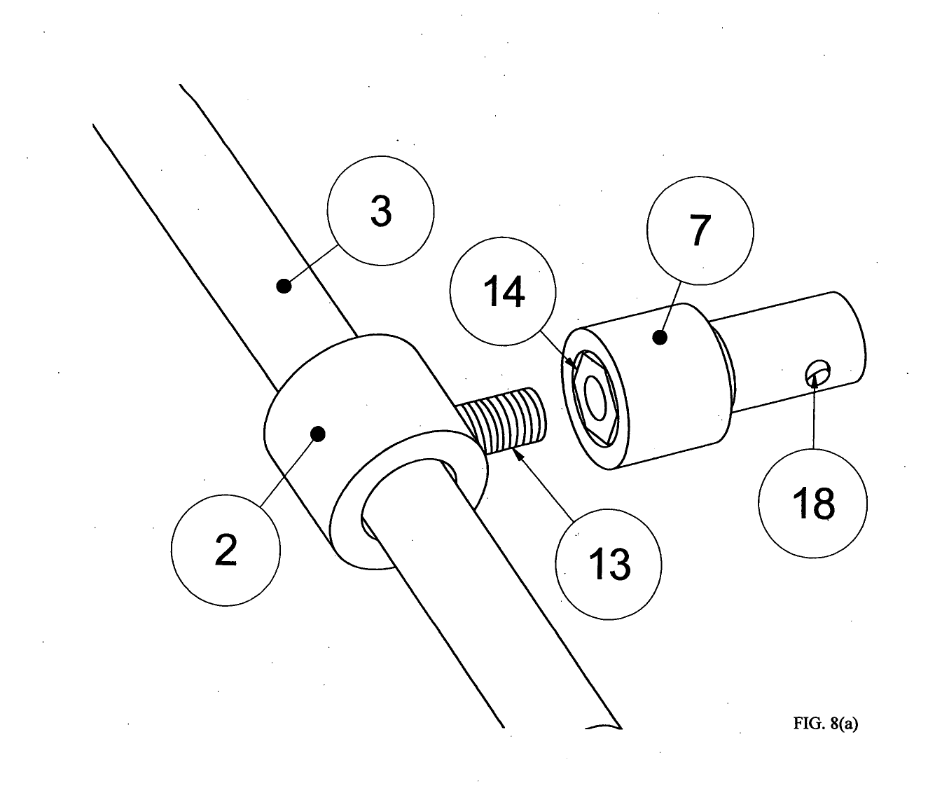

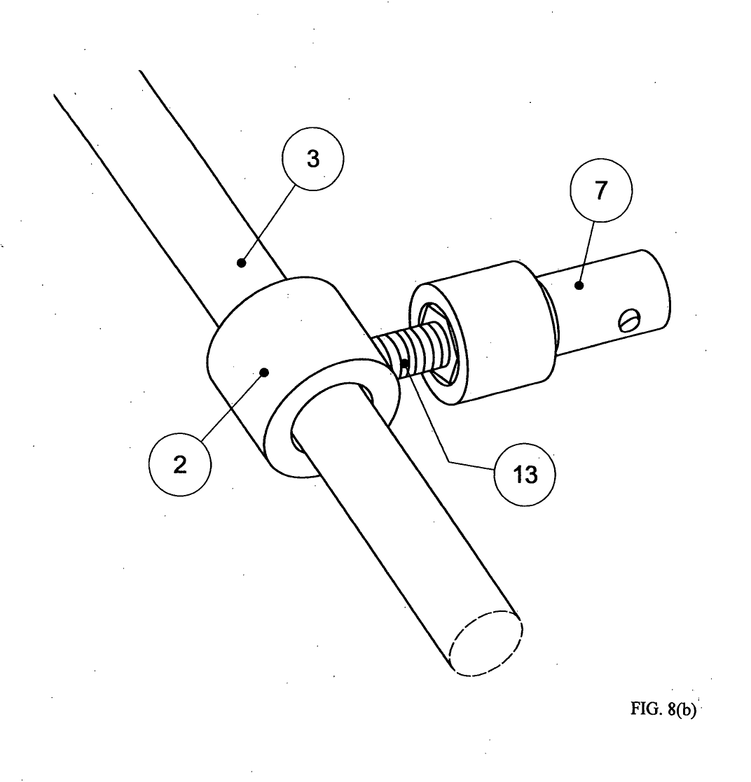

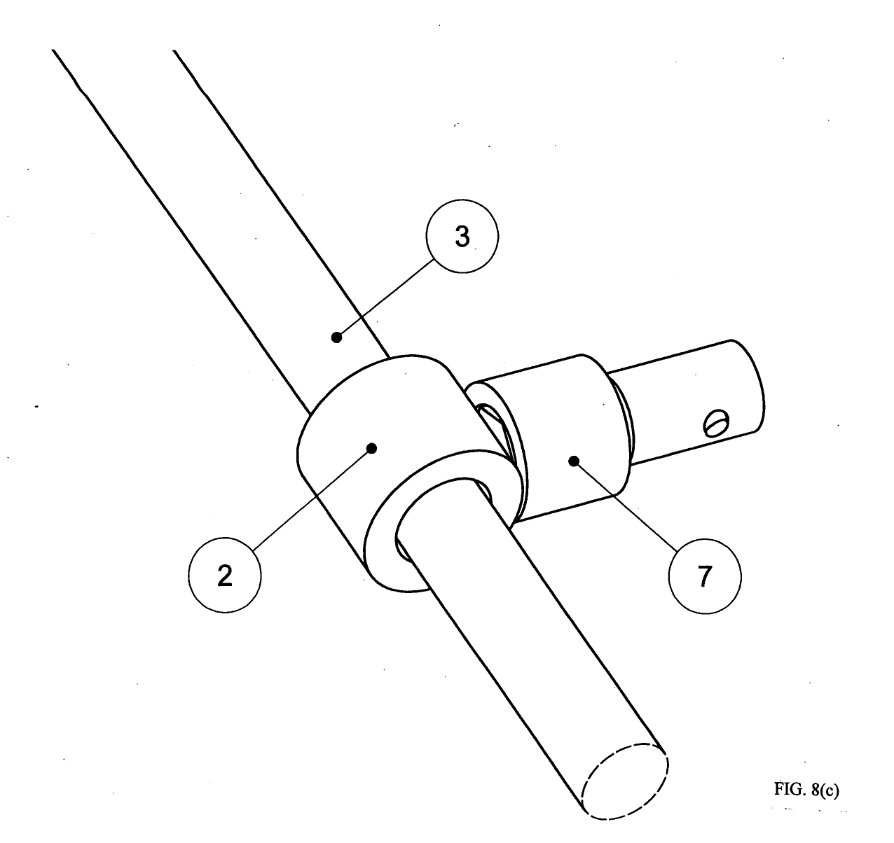

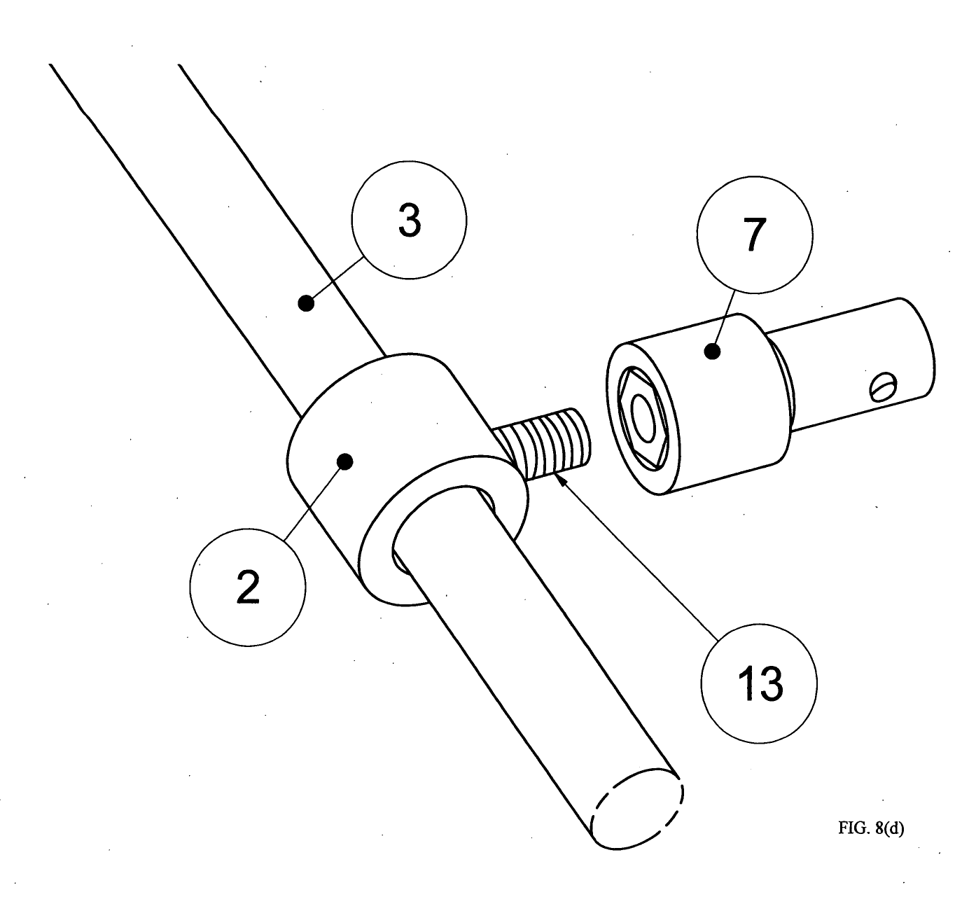

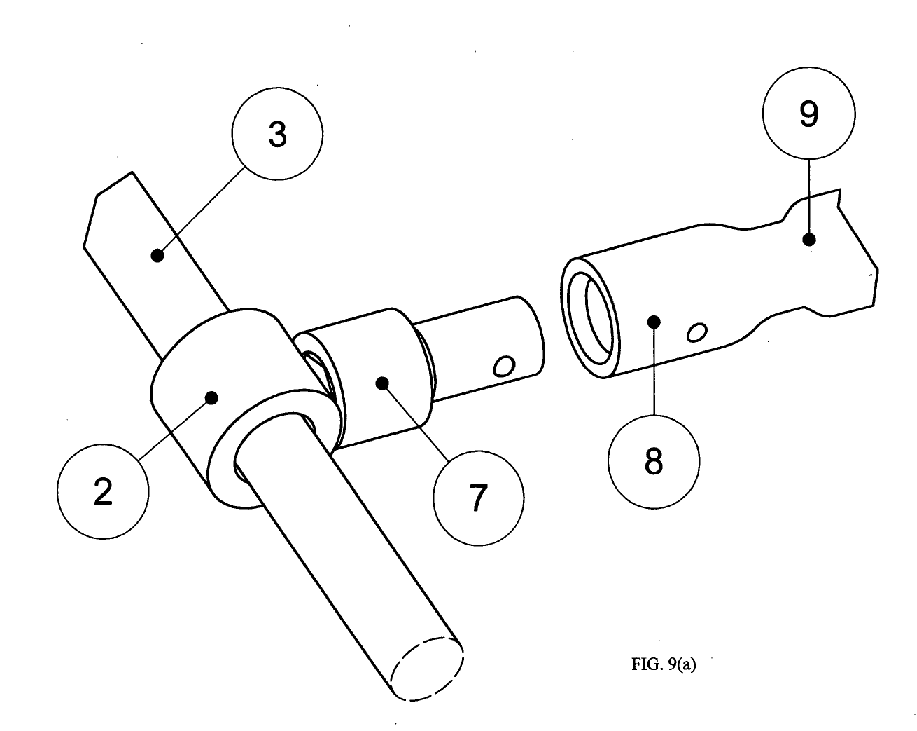

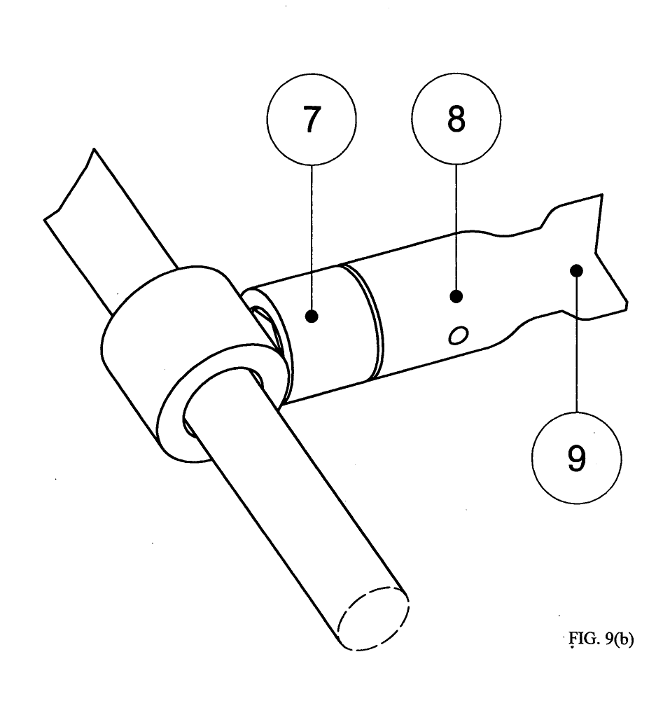

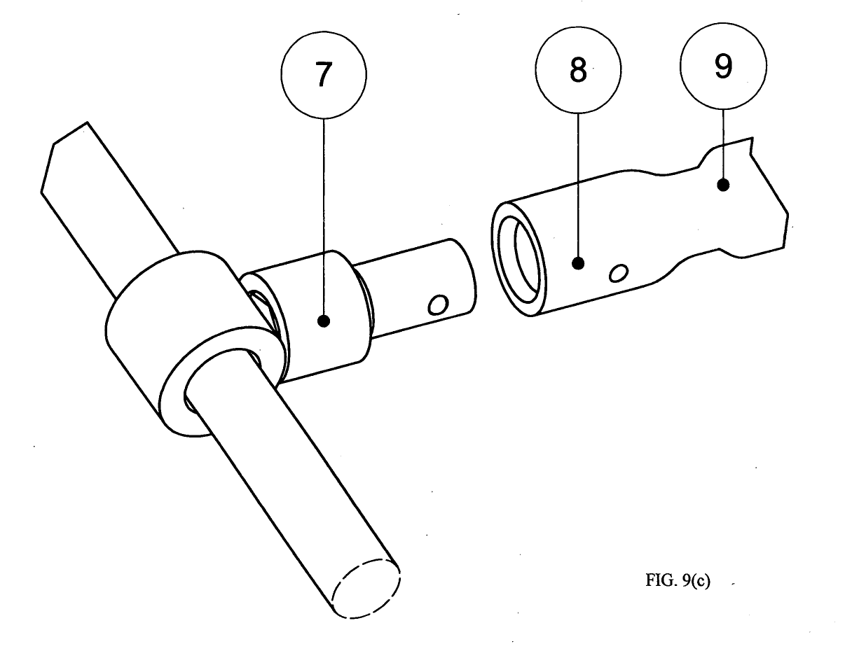

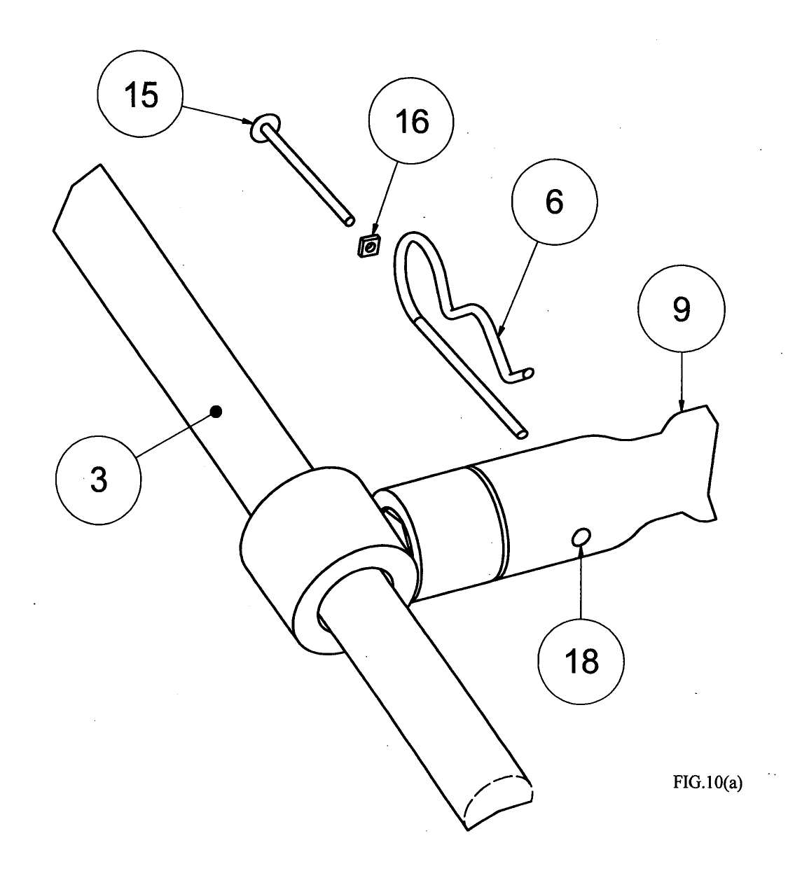

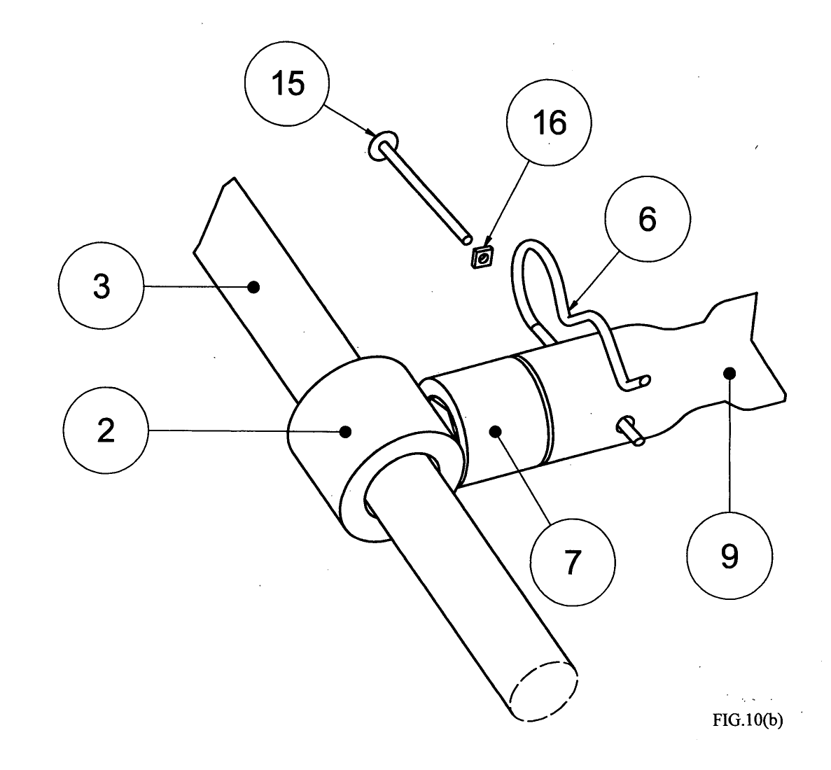

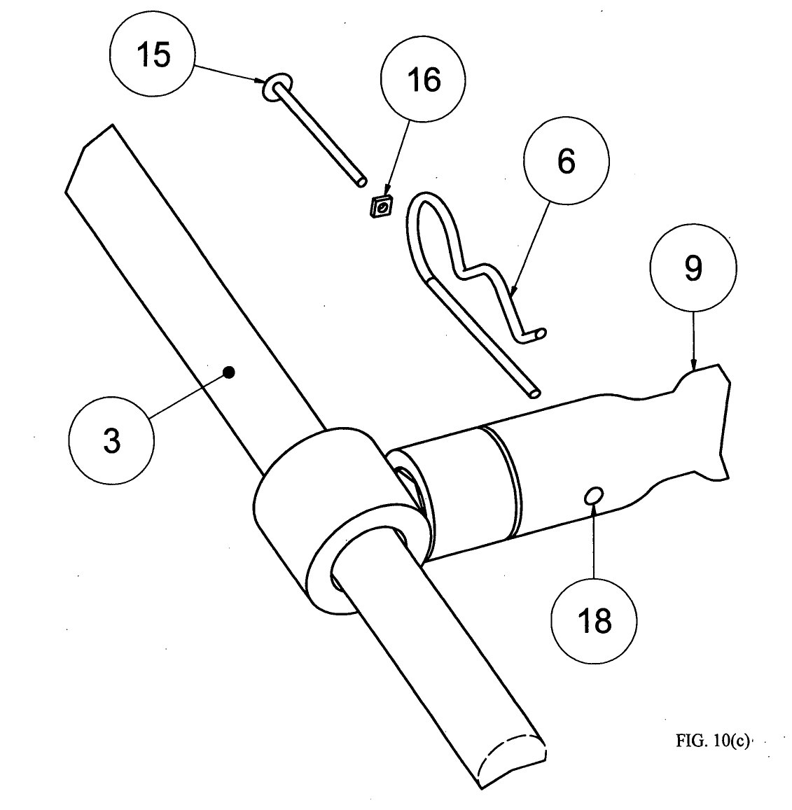

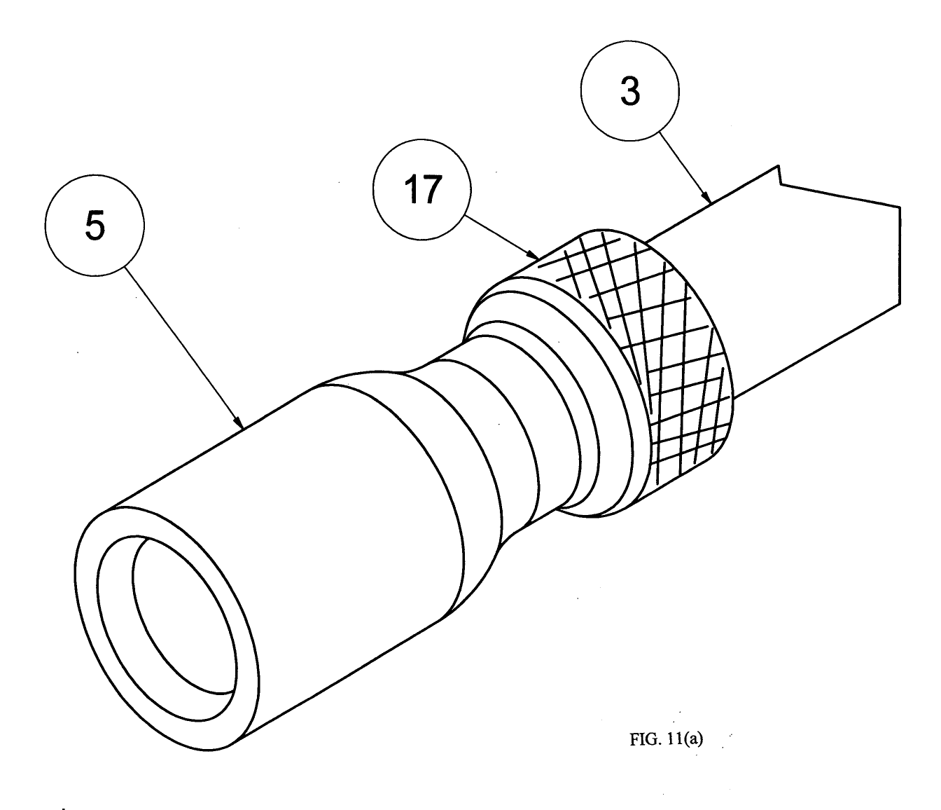

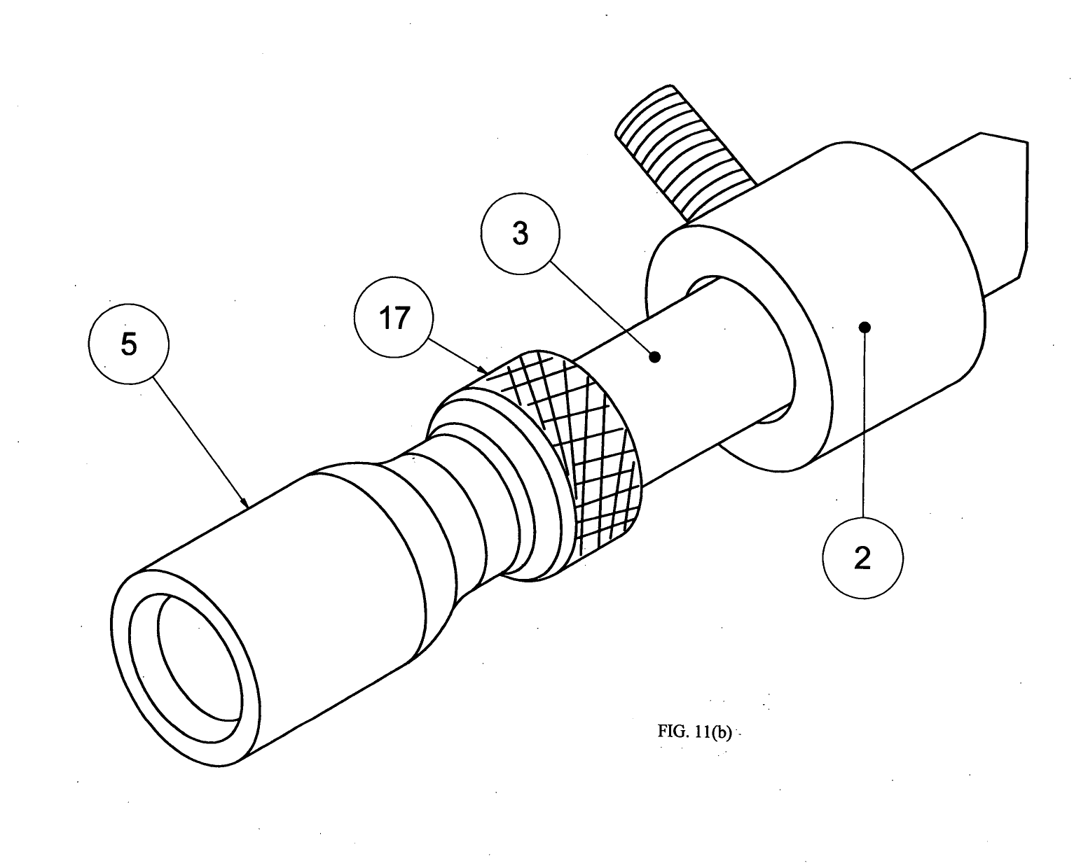

As shown in FIG. 5, is a rear view of the device where the blade angle means connector means 11, blade angle connector means-male socket member 4, articulation means 9, stabilizer support 12, shovel blade 1, and foot support 10 are positioned.

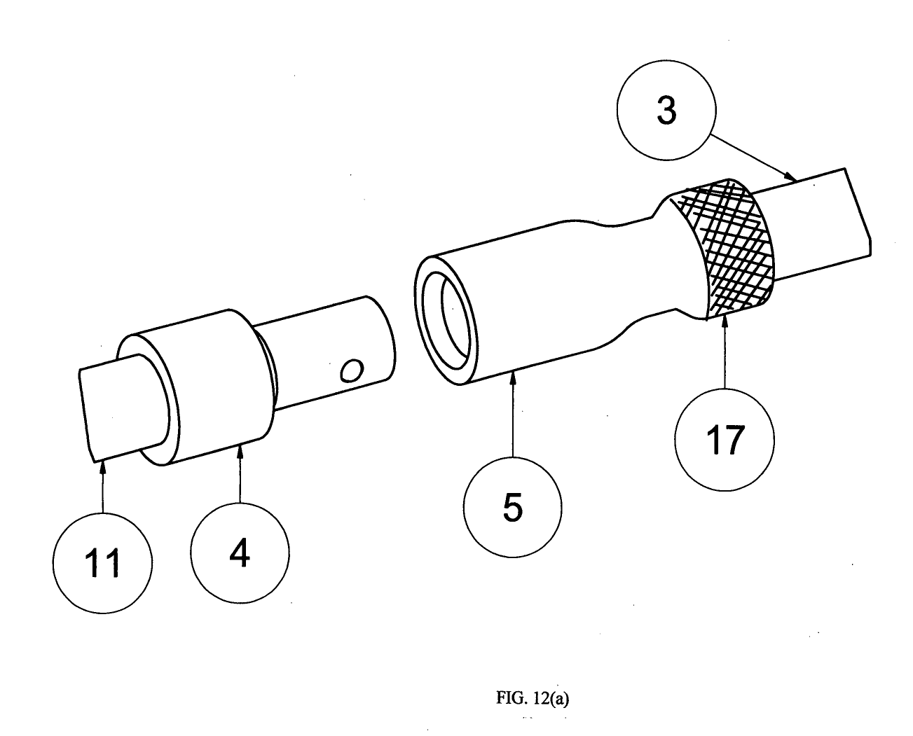

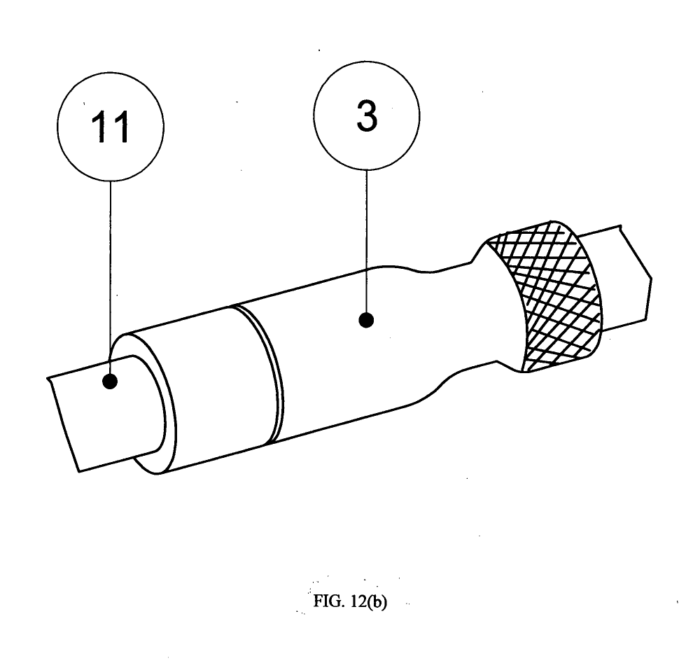

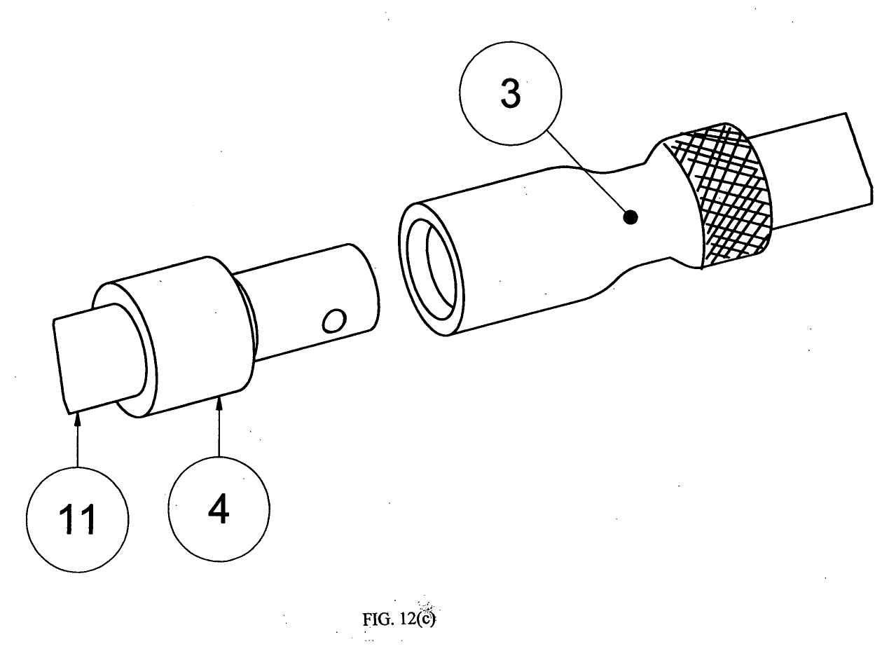

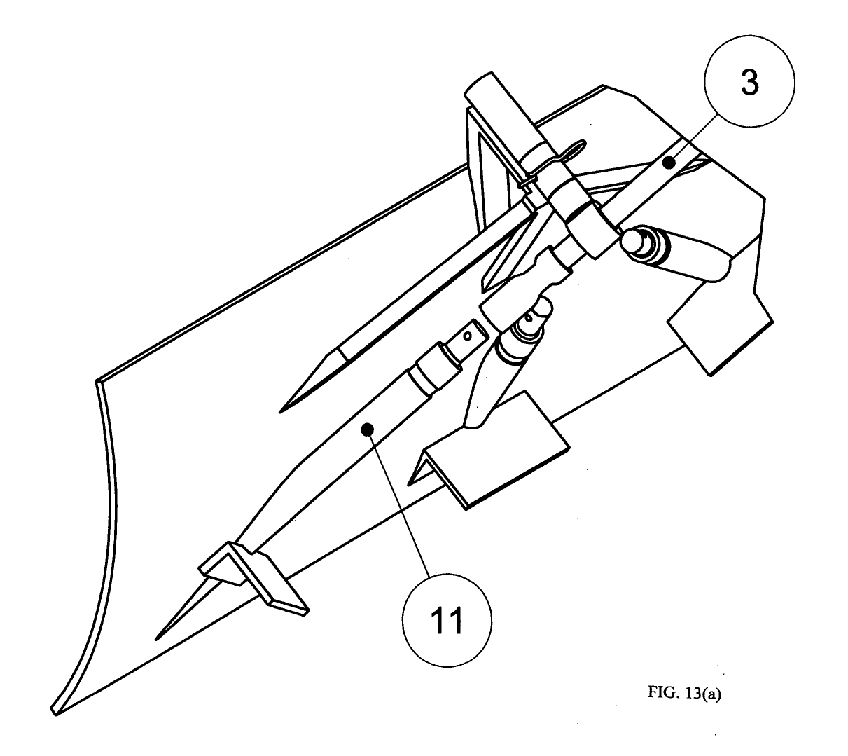

As shown in FIG. 6, the articulation means-male socket member connector nut 14, the articulation means-male socket member 7, articulation means-female socket member 8 and predrilled opening 18 are positioned.

As shown in FIG. 7a, the sliding pivotal collar 2, shovel handle shaft 3, sliding pivotal collar-threaded guide 13, articulation means-male socket member connector nut 14, articulation means-male socket member 7, articulation means-female socket member 8, articulation means 9, hitch pin 6 and bolt-hitch pin alternate 15, nut-hitch pin alternate 16 are positioned.

As shown in FIG. 7b, sliding pivotal collar 2, articulation means-male socket member connector nut 14, pre-drilled opening 18, articulation means-male socket member 7, sliding pivotal collar threaded guide 13, and shovel handle 3 are positioned.

As shown in FIG. 8a, Connecting Sequence by rotating method; by rotating articulation means male socket member connector nut 14 of the articulation means-male socket member 7 clockwise into sliding pivotal collar-threaded guide 13 of the sliding pivotal collar 2, the shovel handle shaft 3 is connected, in preparation for insertion into the articulation means-female socket member 8, as shown in FIG. 9a.

As shown in FIG. 8b, Connecting Sequence by rotating method; by rotating articulation means-male socket member 7 clockwise into sliding pivotal collar-threaded guide 13 as shown in FIG. 8a, the shovel handle shaft 3 is being prepared for insertion into the articulation means-female socket member 8, as shown in FIG. 9a.

As shown in FIG. 8c, Connecting Sequence by rotating method; by rotating articulation means-male socket member 7 clockwise into sliding pivotal collar threaded guide 13 as described in FIG. 8a, the shovel handle shaft 3 is prepared for insertion into the articulation means 9 at the articulation-means female socket member 8, as shown in FIG. 9a.

As shown in FIG. 8d, Disconnecting Sequence by rotating method; by rotating articulation mean-male socket member connector nut 14 of the articulation means-male socket member 7 counter clockwise from sliding pivotal collar-threaded guide 13 of the sliding pivotal collar 2, the shovel handle shaft 3 is removed from the articulation means-male socket member 7.

As shown in FIG. 9a, Connecting Sequence by forward sliding method; articulation means-male socket member 7 attached to sliding pivotal collar-threaded guide 13 as shown in FIG. 8c, is positioned for insertion into articulation means-female socket member 8 at articulation means 9.

As shown in FIG. 9b, Connecting Sequence by forward sliding method; articulation means male socket member 7 as attached to sliding pivotal collar-threaded guide 13 as shown in FIG. 8c is inserted into articulation means-female socket member socket 8 at articulation means 9.

As shown in FIG. 9c, Disconnecting Sequence by rearward sliding method; articulation means male socket member 7 as attached to sliding pivotal collar threaded guide 13 as shown in FIG. 8c is removed from articulation means female socket member 8 at articulation means 9.

As shown in FIG. 10a, Connecting Sequence by forward sliding method; hitch pin 6 or bolt-hitch pin alternate 15 and nut-hitch pin alternate 16 positioned to secure the shovel handle shaft 3 sliding pivotal collar 2 and articulation means-male socket member 7, as shown in FIG. 9b, by inserting into the articulation means 9 through pre-drilled opening 18.

As shown in FIG. 10b, Connecting Sequence by forward sliding method; hitch pin 6 or bolt-hitch pin alternate 15 and nut-hitch pin alternate 16 secured to the shovel handle shaft 3, sliding pivotal collar 2 and articulation means-male socket member 7, as shown in FIG. 9b, after inserting into the articulation means 9 through pre-drilled opening 18.

As shown in FIG. 10c, Disconnecting Sequence by reverse sliding method; removal of hitch pin 6 or bolt-hitch pin alternate 15 and nut-hitch pin alternate 16 from pre-drilled opening 18 disconnect the shovel handle shaft 3, sliding pivotal collar 2 and articulation means-male socket member 7 from the articulation means 9.

As shown in FIG. 11a, is a three dimensional view of the shovel handle shaft retaining-ring 17 attached to shovel handle shaft 3 in relation to shovel handle shaft-female socket member 5.

As shown in FIG. 11b, is a three dimensional view of the shovel handle shaft retaining ring 17, sliding pivotal collar 2 sliding pivotal collar-threaded guide 13 attached to shovel handle shaft 3 in relation to shovel handle shaft-female socket member 5.

As shown in FIG. 12a, is a three dimensional close-up connecting sequence by forward sliding method; the shovel handle shaft 3 positioned for insertion into the blade angle connector means 11.

As shown in FIG. 12b, is a three dimensional close-up connecting sequence by forward sliding method; the shovel handle shaft 3 inserted into the blade angle connector means 11.

As shown in FIG. 12c, is a three dimensional close-up disconnecting sequence by rearward sliding method; the shovel handle shaft 3 removed from blade angle connector means 11.

As shown in FIG. 13a, is a three dimensional rear view connecting sequence of the device by forward sliding method; the shovel handle shaft 3 is positioned for connection to a blade angle socket means 11.

As shown in FIG. 13b, is a three dimensional rear view connecting sequence of the device by forward sliding method; the shovel handle shaft 3 is engaged to a blade angle socket means 11.

As shown in FIG. 13c, is a three dimensional rear view Connecting Sequence of the device by rearward sliding method; the shovel handle shaft 3 is disengaged from a blade angle connector means 11.

As shown in FIG. 14a, is a three dimensional rear view of the device showing the placement of foot support 10 below each blade angle socket connector means 11.

As shown in FIG. 14b, is a three dimensional rear view of the device, shovel handle shaft 3 detached, showing the placement of the blade angle connector means 11 and blade angle connector means-male socket member 4.

The foregoing is a description of a preferred embodiment of the invention which is given here by way of example only. The invention is not to be taken as limited to any of the specific features as described, but comprehends all such variations thereof as come within the scope of the appended claims.

### LEGEND OF A PREFERRED EMBODIMENT

### Item Number:

1. SHOVEL BLADE
2. SLIDING PIVOTAL COLLAR
3. SHOVEL HANDLE SHAFT
4. BLADE ANGLE CONNECTOR MEANS-MALE SOCKET MEMBER
5. SHOVEL HANDLE SHAFT-FEMALE SOCKET MEMBER
6. HITCH PIN
7. ARTICULATION MEANS-MALE SOCKET MEMBER
8. ARTICULATION MEANS-FEMALE SOCKET MEMBER
9. ARTICULATION MEANS
10. FOOT SUPPORT
11. BLADE ANGLE CONNECTOR MEANS
12. STABILIZER SUPPORT
13. SLIDING PIVOTAL COLLAR-THREADED GUIDE
14. ARTICULATION MEANS-MALE SOCKET MEMBER CONNECTOR NUT
15. BOLT-HITCH PIN ALTERNATE
16. NUT-HITCH PIN ALTERNATE
17. SHOVEL HANDLE SHAFT-RETAINING RING
18. PRE-DRILLED OPENING

What is claimed:

1. A manually operable shovel for efficiently moving material, comprising:
a shovel;
a shovel handle;
a handle pole extending from the shovel handle;
a joint means which attaches the shovel blade to the handle pole;
a pivotal collar which houses the handle pole to attach to the shovel blade joint;
a connector means comprising at least one hitch pin or alternatively 1 nut and bolt interconnecting the first joint member to the second joint member of the aforementioned joint means;
an articulation means permanently attached to the shovel blade cooperating with said joint means permitting the operator to position said blade to a pre-determined angle in relations to the direction of blade movement; said articulation means connects said pivotable collar; wherein;
the variable distance between shovel pole and respective angular settings are interconnected by male and female angular snap fit connectors; and said pivotable collar, as connected, permits the handle pole upward and downward axis travel to interconnect said male and female annular snap fit connectors at said angular settings; and further wherein;
said pivotal collar, facilitates the shovel pole movement to swivel on an axis to interconnect said annular snap fit connectors, whereby the shovel is adaptable for selectively pushing and displacing or lifting and displacing the material.

2. A manually operable shovel according to claim 1, wherein said first joint member comprises a female joint member attached to the blade and the second joint member comprises a male joint member interconnectedly received in said female joint member, and wherein the connector means comprises: 1 hitch pin key carried by the female joint member and extending through the male joint member or, alternatively carried by one nut and bolt similarly so extended wherein either said hitch pin key or nut and bolt secure upper connector means to handle pole; and further wherein said articulation means comprises: an annular snap fit connection forced in the female joint member and oriented generally in the direction of blade movement which the joint means is positioned for both translational and rotational movement; and, a traverse opening in the female joint for receiving said hitch pin key or alternatively, for receiving said nut and bolt, interlocking the male joint means to the blade reciprocating between locked and unlocked positions and in rotational movements of the handle pole as the user moves the blade into a desired angle in relation to direction of blade movement;

3. A manually operable shovel according to claim 2, wherein said female joint member comprises a housing to manually receive said male joint member traversely attached to said pivotal collar attached to the handle pole;

4. A manually operable shovel according to claim 2 or 3, wherein said shovel handle comprises an elongate shaft extending through said pivotal collar; and said pivotal collar is joined by threaded guide to a connector nut within a traversely mated male joint means for being locked at said articulation means; and a stabilizer bar attached to said articulation means generally traverse to said shovel blade for permitting the user to manually stabilize the shovel;

5. A manually operable shovel according to claim 4, wherein said shovel handle is pivotally locked in a predetermined angular setting to move material away from the user at either side of the direction selected;

6. A manually operable shovel according to claim 5, wherein the shovel handle comprises an elongate bar extending to joint means, wherein the pre-set angle of the shovel blade is selected on an axis with the articulation means;

7. A manually operable shovel according to claim 6, wherein the joint means where the shovel handle is locked in pre-set position, said joint means are underlet with foot supports to manually stabilize the shovel while unlocked;

8. A manually operable shovel according to claim 7, wherein the joint means attached to the shovel handle intermatingly connected to pre-determined annular settings are connected by the user engaging forward, rearward, radial and axial movement as controlled by said pivotable collar housing the shovel handle shaft.
